(19) United States
(12) Patent Application Publication
(10) Pub. No.: US 2022/0369781 A1
(43) Pub. Date: Nov. 24, 2022

(54) COLLAPSIBLE HANDLE ASSEMBLY

(71) Applicant: KETER HOME AND GARDEN PRODUCTS LTD, Herzliya (IL)

(72) Inventors: Yaron BRUNNER, Kibbutz Gvat (IL); Ayala VARDI BOUGAY, Kefar Veradim (IL); Uri PARIZER, Kibbutz Hukok (IL); Ron SONNENBERG, Givat Ela (IL)

(21) Appl. No.: 17/790,779

(22) PCT Filed: Nov. 15, 2020
(86) PCT No.: PCT/IL2020/051177

§ 371 Date: Jul. 5, 2022

(30) Foreign Application Priority Data
Jan. 5, 2020 (IL) 271834

(51) Int. Cl. A45C 13/26; A45C 5/14; B62B 5/06; B62B 1/12

(52) U.S. Cl. CPC A45C 13/262; A45C 5/14; B62B 5/067; B62B 1/125; A45C 2013/267; B62B 2205/20; B25H 3/02

(57) ABSTRACT

The disclosure provides a wheeled container assembly (10) and a handle assembly (20) for a container, the handle assembly comprising a pair of pa ra Nelly disposed leg members (24, 26), each leg member comprising a first leg segment (32) articulable to the container, a second leg segment (34) telescopically displaceable with respect to said first leg segment, and a third leg segment (36) telescopically displaceable with respect to said second leg segment; a bridge member (40) rigidly extending between an upper portion the first leg segments, and a manipulating handle (42) rigidly extending between a top portion of the third leg segments; the leg members are configurable between a locked extended position and a locked retracted position; a primary locking mechanism (120); and a secondary locking mechanism (50); and wherein retracting the third leg segment into the second leg segment is facilitated after retraction of the second leg segment into the first leg segment.

### TECHNOLOGICAL FIELD

The present disclosure is generally in the field of collapsible handles used with locomotive containers.

The term container as used herein denotes any type of container or cart, e.g. used as a tool caddy, organizer, traveler bag, cosmetics bag, storage containers, etc.

### BACKGROUND ART

References considered to be relevant as background to the presently disclosed subject matter are listed below:
WO 2017/098511

Acknowledgement of the above references herein is not to be inferred as meaning that these are in any way relevant to the patentability of the presently disclosed subject matter.

### BACKGROUND

WO 2017/098511 discloses a wheeled container having a handle assembly that is configured for providing support to an assembly of containers when in a rest position and for permitting locomoting of the assembly upon demand.

### GENERAL DESCRIPTION

In one of its aspects, there is provided a handle assembly for a container, the handle assembly comprising a pair of parallelly disposed leg members, each leg member comprising a first leg segment articulable to the container, a second leg segment telescopically displaceable with respect to said first leg segment, and a third leg segment telescopically displaceable with respect to said second leg segment; a bridge member rigidly extending between an upper portion the first leg segments, and a manipulating handle rigidly extending between a top portion of the third leg segments;

the leg members are configurable between a locked extended position, at which the leg segments of a leg member are telescopically extended with respect to one another, and a locked retracted position, at which the leg segments of a leg member are telescopically retracted and the handle assembly assumes a minimal height;

a primary locking mechanism disposed at the bridge member and configured for arresting the second leg segment within the first leg segment and the third leg segment within the second leg segment, at the retracted position; and a secondary locking mechanism disposed within a bottom portion of the third leg segment and configured for arresting the third leg segment at the extended position with respect to the second leg segment; and wherein retracting the third leg segment into the second leg segment is facilitated after retraction of the second leg segment into the first leg segment.

In another aspect, the present disclosure also concerns a wheeled container assembly comprising at least a base container, said base container configured with a wheel set disposed at a rear portion thereof, and a handle assembly, said handle assembly comprising: a pair of parallelly disposed leg members, each leg member comprising a first leg segment articulated at a back wall portion of the base container, a second leg segment telescopically displaceable with respect to said first leg segment, and a third leg segment telescopically displaceable with respect to said second leg segment; a bridge member rigidly extending between an upper portion the first leg segments, and a manipulating handle rigidly extending between a top portion of the third leg segments; the leg members are configurable between a locked extended position, at which the leg segments of a leg member are telescopically extended with respect to one another, and a locked retracted position, at which the leg segments of a leg member are telescopically retracted and the handle assembly assumes a minimal height; a primary locking mechanism disposed at the bridge member and configured for arresting the second leg segment within the first leg segment and the third leg segment within the second leg segment, at the retracted position; and a secondary locking mechanism disposed within a bottom portion of the third leg segment and configured for arresting the third leg segment at the extended position with respect to the second leg segment; and wherein retracting the third leg segment into the second leg segment is facilitated after retraction of the second leg segment into the first leg segment.

The primary locking mechanism comprises a primary plunger configured for snap engagement within a first arresting recess configured at a top portion of the first leg segment and a second arresting recess at a bottom portion of the second leg segment, said first arresting recess and second arresting recess being disposed in register with one another. The arrangement is such that when the plunger is engaged within both said first arresting recess and second arresting recess, the second leg segment is arrested at its extended position with respect to the first leg segment, and when the plunger is retracted against its biasing, said second leg segment can be retracted into the collapsed position within the first leg segment.

The arrangement is such that retracting or expanding the handle assembly is facilitated only upon releasing the primary locking mechanism.

The secondary locking mechanism comprises a secondary plunger disposed within a bottom portion of the third leg segment, said plunger being normally biased to project from a recess at a side wall of the third leg segment and is configured to snap into arresting engagement within a recess deposed in register at a top portion of the second leg segment.

The secondary plunger is configured with a gliding surface at least at a bottom face thereof, facilitating sliding over an arresting location. The gliding surface of the secondary plunger can be chamfered or rounded.

The secondary plunger can be retained within a housing secured at a bottom portion of the second leg segment.

The secondary plunger is spring loaded into its normally biased position, wherein at the retracted position and at the expanded position the spring is substantially at a non-compressed (or non-tensioned) position. At intermediate positions of the handle assembly, when the third leg segment and the second leg segment are in transition, between the retracted position and the expanded position, the spring is loaded (i.e. at a compressed/tensioned position).

One or more support sleeves can be fixed at respective ends of the leg segments, to facilitate smooth sliding of the leg segments with respect to one another and to reduce tolerances therebetween. According to a particular configuration of the disclosure, the second leg segment is configured at a bottom portion thereof with an external sleeve, and at a top portion thereof with an internal sleeve. The external sleeve has at least external surface portions configured for sliding along the inside surface of the first leg segment, and the internal sleeve has at least inside surface portions configured for slidingly supporting the outside surface of the third leg segment.

At the retracted position, the primary locking mechanism arrests the second leg segment and third leg second within the first leg segment, thereby preventing the handle assembly from displacing into its expanded position.

Displacing the handle assembly from the retracted portion into the expanded position is possible only upon releasing/unlocking the primary locking mechanism.

Upon retraction displacing of the second leg segment into the first leg segment, the secondary plunger, projecting through an aperture at the third leg segment and a corresponding aperture at the second leg segment, encounters a top release shoulder configured at a top portion of the bridge member, wherein further axial displacing of the leg member into the retracted position entails momentary contraction of the secondary plunger to thereby facilitate further displacement into the fully retracted position.

Upon axially extending the third leg segment and the second leg segment from the fully retracted position, in an upwards direction, the secondary plunger encounters a bottom release shoulder, resulting in momentary contraction of the secondary plunger, facilitating full extension of the third leg segment from the second leg segment into full leg member expansion.

The arrangement is such that expanding a leg member is facilitated only upon manually releasing the primary locking mechanism, whereupon the secondary locking mechanism spontaneously displaces into its momentarily open position, facilitating axial withdrawal of the second leg segment and the second leg segment, respectively, into the fully expanded position.

Likewise, collapsing the handle assembly is facilitated only upon manually releasing the primary locking mechanism, enabling axial collapsing of the second leg segment and the third leg segment into the first leg segment, at a telescoping mode, whereupon the secondary locking mechanism spontaneously displaces into its momentarily open position.

The primary plunger can be normally biased into a locked position, wherein a locking tip of the primary plunger projects from a side portion of the bridge member, and is configured for projecting through an aperture configured at a top portion of the first leg segment into locking arresting of the second leg segment and the third leg segment, through a locking aperture configured at a top portion of each leg segment, respectively.

The primary locking mechanism is configured with an unlocking mechanism configured for contracting the normally biased primary plunger into its unlocked position.

The unlocking mechanism can be biased so as to normally retain a locked position.

According to a particular example, the unlocking member at the bridge member comprises an actuator configured for retracting the primary plunger from its arresting position where it projects into the locking aperture at the top portion of the first leg segment (at the extended position), or into the coinciding locking apertures at the top portion of all leg segments (at the retracted position).

According to a particular configuration, the primary plunger is normally biased, or articulated with a biasing arrangement, configured for projecting into the arresting position.

The actuator can be configured for simultaneous retracting two primary plungers, towards one another, each associated with a respective leg member of the handle assembly. The actuator can be a push button, a pull lever, a turn knob, a slider, etc.

According to one particular arrangement, the actuator is a push button received at a center portion of the bridge member and configured with two activating surfaces oppositely sloping with respect to an actuator displacing axis of the actuator, whilst two primary plungers are received within the bridge member and are slidingly displaceable along a plunger axis extending normal to said actuator displacing axis; each of said primary plungers is configured at a neighboring end portion with a sloping activated surface, the respective activated surfaces extending at an opposite sense and being correspondently inclined with respect to said two activating surfaces.

The arrangement being such that axial displacing of the push button along the actuator displacing axis results in the two activating surfaces sliding over the corresponding activated surfaces, entailing axial displacement of the two primary plungers towards one another, along the plunger axis, so as to contract, i.e. into unlocking the handle assembly.

Where there is a biasing arrangement, a biasing member can be provided for obtaining the biasing effect. For example, a biasing spring can be configured between the two primary plungers, applying a pushing force therebetween. Alternatively, or in addition, a biasing element can be articulated with the actuator, so as to bias it into the normally un-activated (un-pressed) position.

The term minimal height as used herein denotes the height between a bottom surface of the container and a topmost surface of the manipulating handle, when the container is at an upright position.

It is appreciated that the two leg members are substantially symmetric, though a locking arrangement can be configured in either one or both leg members. However, for practical reasons, the handle assembly can be symmetric also as far as the locking arrangement.

According to a modification of the disclosure, the first leg segments can be configured as an integral part of the container.

Any one or more of the following features, designs and configurations, can be implemented in a container handle assembly and a container fitted with a handle assembly, according to the present disclosure, individually or in various combinations thereof:
Extending the third leg segment from the second leg segment is facilitated after extending the second leg segment from the first leg segment;
The maximum length of the handle assembly, at the fully retracted/collapsed position, does not exceed about 20 inches, measured from a ground engaging surface of the container to a topmost portion of the handle, when the container assembly is at an upright position;
The manipulating handle can extend offset with respect to a longitudinal axis of the leg members, such that an innermost face thereof extends spaced from an outermost face of the bridge member;
The handle assembly can be articulable to a bottom, wheeled container of a multi-level container assembly;
The handle assembly can be articulable to a wheeled container;
The handle assembly can be articulable to a wheeled container, wherein a longitudinal axis of the leg members can extend behind an axis of wheels of the container;
The handle assembly can be articulable to a wheeled container with a longitudinal axis of the leg disposed before or behind or coinciding with a back wall of the container;
The handle assembly can be articulable to a bottom face of a bottom wall of a wheeled container;
The handle assembly can be articulable to any container of a container assembly;
The handle assembly can be fixedly secured or removably secured to the container;
The handle assembly can be articulated to a container by securing the first leg segment of each leg member to a wall portion of the container;
The handle assembly can be articulated to a container by securing the first leg segment of each leg member within a corresponding receiving channel configured at a rear portion of the container;
The handle assembly can be configured as a ladder-shaped construction; The bridge member is rigidly articulated or integral with or integrated with the first leg segments;
The manipulating handle can extend offset with respect to a longitudinal axis of the leg members, in a direction facing away from the container;
The manipulating handle can be configured with a gripping portion disposed parallel to the bridge member and normal to the leg members;
The one or more support sleeves can be made of a polymeric material;
The top release shoulder of the bridge member can be configured with a chamfered gliding surface;
The bottom release shoulder of the bridge member can be configured with a chamfered gliding surface;
The top release shoulder and the bottom release shoulder can be unitary;
The first leg segment and the second leg segment and the third leg segment can be tubular elements, and the arresting recess is configured at a side wall portion thereof;
The handle assembly can be articulated at a bottom portion thereof with a wheel assembly. The wheel assembly can be fixedly or removably articulated to the handle assembly and the handle assembly can be removably or fixedly attached to the container.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a front perspective view of a container assembly according to an example of the disclosure, configured with a handle assembly according to the disclosure, the handle assembly at a fully extended position;

FIG. 1B is back side, perspective view of the assembly seen in FIG. 1A;

FIG. 2A is a back side, perspective view of the handle assembly seen in FIG. 1A, isolated from a container;

FIG. 2B is an exploded perspective view, of right-side components of FIG. 2A;

FIG. 2C is an enlarged view of the portion marked 2C in FIG. 2B;

FIG. 2D is an enlarged, exploded view, of the portion marked 2D in FIG. 2B, directed to a primary locking mechanism;

FIG. 3A is an enlarged view of the portion marked 3A in FIG. 1B;

FIG. 3B is an enlarged view of the portion marked 3B in FIG. 1B;

FIG. 3C is an enlarged view of the portion marked 3C in FIG. 1B;

FIG. 3D is a section taken along line 3D-3D in FIG. 3B;

FIG. 4A is a section taken along line 4A-4A in FIG. 3C;

FIG. 4B is a sectioned perspective view, of portion IV seen in FIG. 4A, illustrating the primary locking mechanism at a normally locked position:

FIG. 4C is a sectioned perspective view, of portion IV seen in FIG. 4A, illustrating the primary locking mechanism at a temporarily unlocked position:

FIG. 5A is a perspective rear view of the container of FIG. 1B, with the handle assembly at an intermediately retracted position;

FIG. 5B illustrates the handle assembly of FIG. 5A, isolated from the container;

FIG. 6A is a front side perspective view of the container of FIG. 1A, with the handle assembly at a fully retracted position;

FIG. 6B is a rear side perspective view of the assembly seen in FIG. 6A;

FIG. 6C is a side view of the assembly seen in FIG. 6A;

FIG. 7A illustrates a portion of the handle assembly of FIG. 6B, with the actuator of the primary locking mechanism at a depressed, unlocking position;

FIG. 7B is a section taken along line 7B-7B in FIG. 7A;

FIG. 7C is an enlargement of the portion marked 7C in FIG. 7B;

FIG. 8A is a sectioned view of a portion of the handle assembly (taken along line 7B-7B in FIG. 7A), at a retracting instance of the handle assembly, illustrating the secondary locking mechanism engaging a top release shoulder configured at a top portion of the bridge member; and

FIG. 8B is a sectioned view of a portion of the handle assembly (taken along line 7B-7B in FIG. 7A), at an extending instance of the handle assembly, illustrating the secondary locking mechanism engaging a bottom release shoulder configured at a top portion of the bridge member.

### DETAILED DESCRIPTION OF EMBODIMENTS

Attention is directed to the annexed drawings, illustrating a wheeled container with a handle assembly, generally designated 10, wherein the container 12 is a wheeled container configured with a pair of wheels 14 configured at a back portion of the container 12, and a collapsible handle assembly, generally designated 20, integrated at a back wall 16 of the container 12.

In the illustrated example, the container assembly 12 is a top-open container with an integral set of rear wheels 14, used for example as a toolbox. However, it should be appreciated that the term “container” is used at its broad sense, whereby a container according to the disclosure can be a set of containers, a cart, e.g. used as a tool caddy, organizer, traveler bag, cosmetics bag, storage containers, etc., of any type, shape and configuration.

In the present example, the handle assembly 20 is integrated with the container 12, whereby the back wall 16 of the container is configured with a pair of closed receiving channels 18 into which a bottom segment of the handle assembly 20 is secured, as will be explained below. The handle assembly 20 can be fixedly or detachably secured to the container 12 and articulation of the handle assembly can be configured at either side of a wall portion of the container (i.e. inside or outside the container), or even the handle assembly can be articulated to a bottom or top wall of the container (not shown).

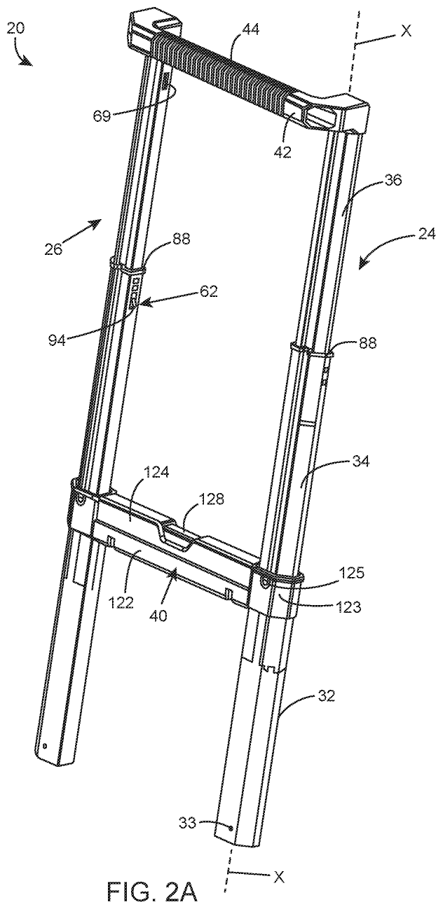

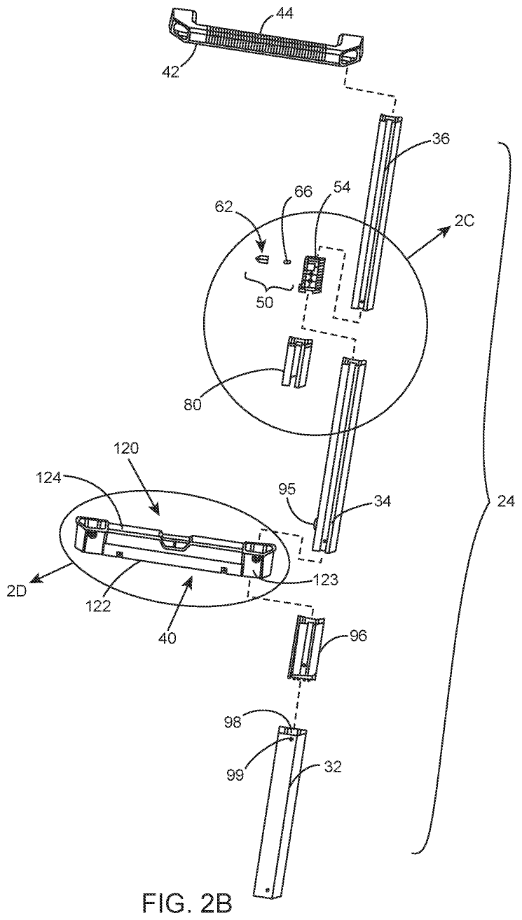

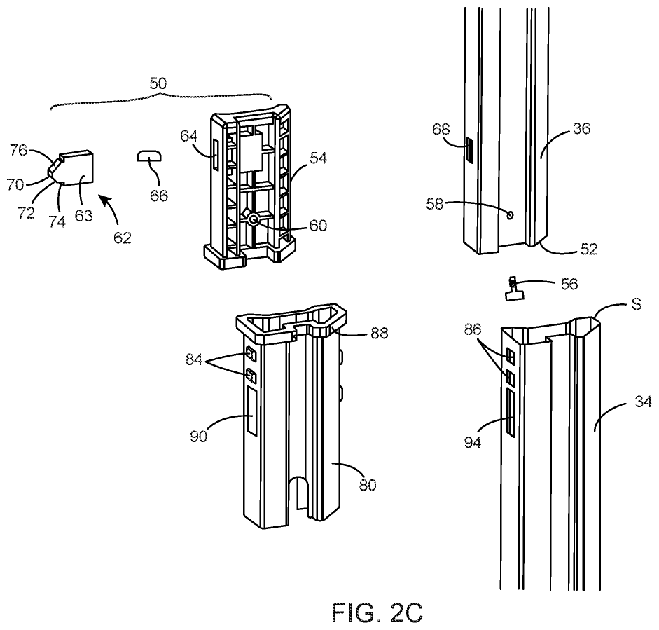

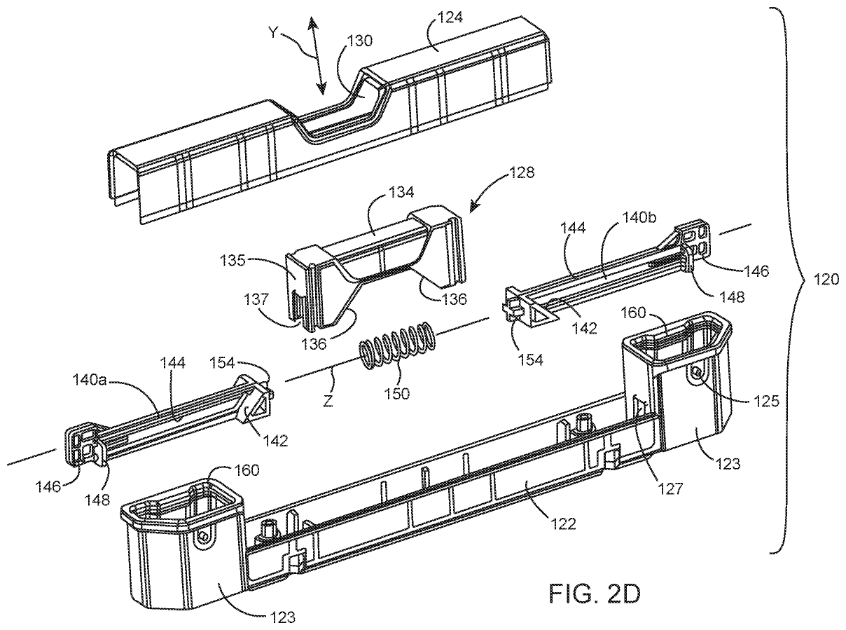

The handle assembly 20, as can be seen better in FIGS. 2A and 2B, is symmetric about its length and comprises a pair of parallelly disposed leg members, namely a right leg member 24 and a left leg member 26. Noting symmetry between the two leg members 24 and 26, reference is made hereonwards to only the right side leg member 24, though it is appreciated that the left side leg member 26 is of identical structure and operates the same, as will be discussed hereinafter.

Hence, each of the leg members 24 and 26 which comprises a first (bottom) leg segment 32 articulable to the container 12 by insertion into the receiving channels 18 and securing by fasteners through apertures 33. A second (intermediate) leg segment 34 is telescopically displaceable with respect to said first leg segment 32, and a third (top) leg segment 36 is telescopically displaceable with respect to said second leg segment 34. The three leg segments are telescopically retained and are coaxially disposed along a longitudinal axis X. The leg segments are shaped as closed tubular segments, with a figured cross-section S (seen for example in FIG. 2C) for increasing the strength thereof.

A bridge member 40 rigidly extending between an upper portion of the first leg segments 32, and a manipulating handle 42 rigidly extending between a top portion of the third leg segments 36. In the present example, the manipulating handle 42 is configured with a gripping portion 44 and it is seen that the manipulating handle 42 is offset with respect to the longitudinal axis X of the leg members, such that it extends away from the back wall 16 of the container 12.

A secondary locking mechanism generally designated 50 (FIGS. 2B-2C) is disposed within a bottom portion of the third leg segment 36, through end 52, and comprises a housing 54 securely fitted within the third leg segment 36 and secured in place by a bolt 56 extending through opening 58 (at the bottom of third leg segment 36) into bore 60 of housing 54. The housing 54 slidingly accommodates a secondary plunger 62 disposed within a receiving cavity 64 and biased to normally project therefrom by a coiled compression spring 66. The housing 54 is positioned within the third leg segment 36 such that the receiving cavity 64 (with the secondary plunger 62 received therein) is disposed in register with an opening 68 configured at a side wall of the third leg segment 36.

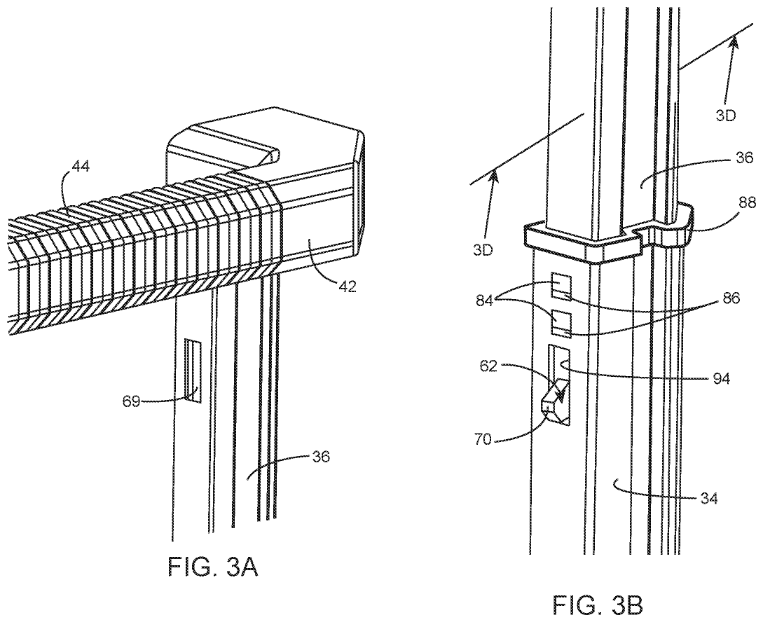

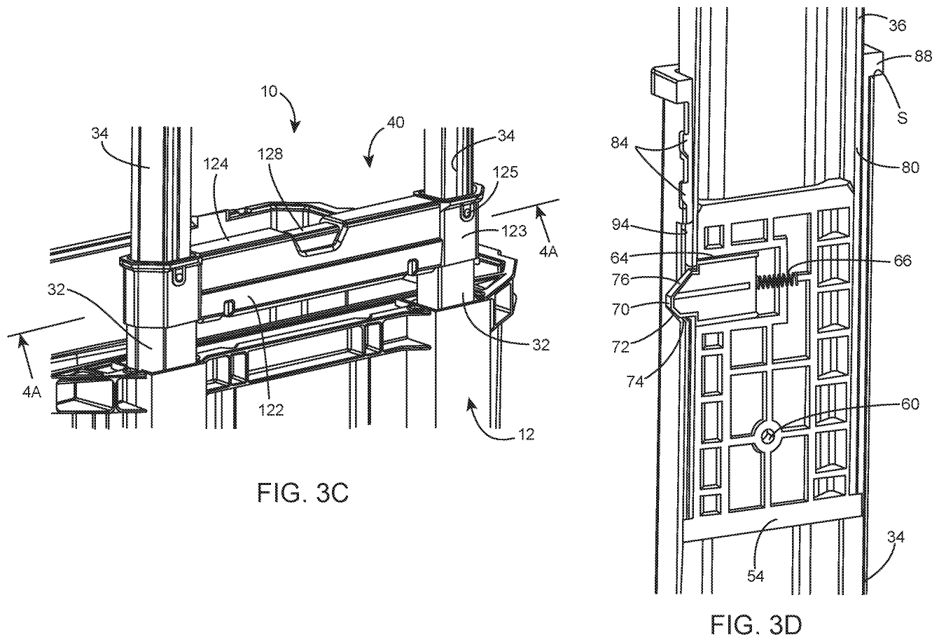

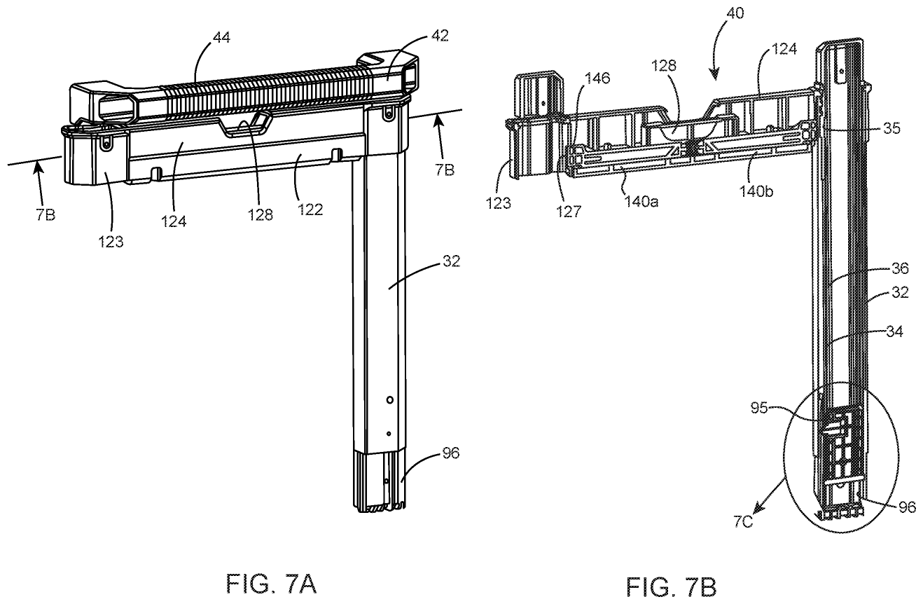

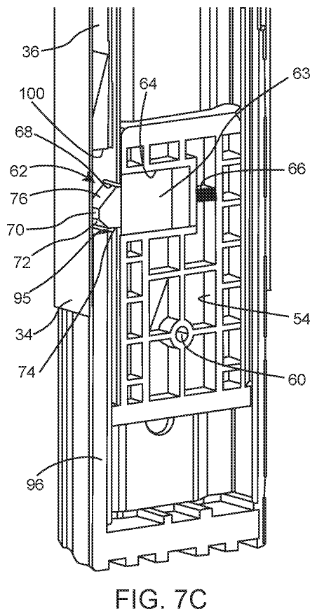

The secondary plunger 62 has a rectangle-shaped body portion 63 for sliding displacement within the receiving cavity 64, and a projecting tip 70 with a chamfered bottom plane 72 extending from a flat surface 74, and chamfered top plane 76 (seen also in FIGS. 3D and 7C).

It is seen that the third leg segment 36 is configured at a top portion of a side wall thereof (same side wall as opening 68) with an opening 69, the purpose of which will be clarified hereinafter.

A support sleeve 80 is snugly received within a top end of the second leg segment 34 and secured in place by snapping bulges 84 configured for protrusion through arresting openings 86 at the top end of the second leg segment 34, wherein at assembly, a top rim 88 of the sleeve 80 bears over the top edge S of the second leg segment 34. The sleeve 80 is further configured with a side facing opening 90 which at the assembled position extents in register with a corresponding opening 94 at a top portion of the second leg segment 34. It is appreciated that the inside cross section of the sleeve 80 corresponds with an external section of the third leg segment 36 so that the latter can slidingly displace within the former, though with reduced tolerances therebetween. For that propose, the sleeve 80 can be made from a polymeric material. Also noted, the opening 94 corresponds with position of the opening 68 at the side wall of the third leg segment 36, and is slightly greater. The second leg segment 34 is further configured at a bottom portion thereof, on an inwards facing side wall, with a locking opening 95.

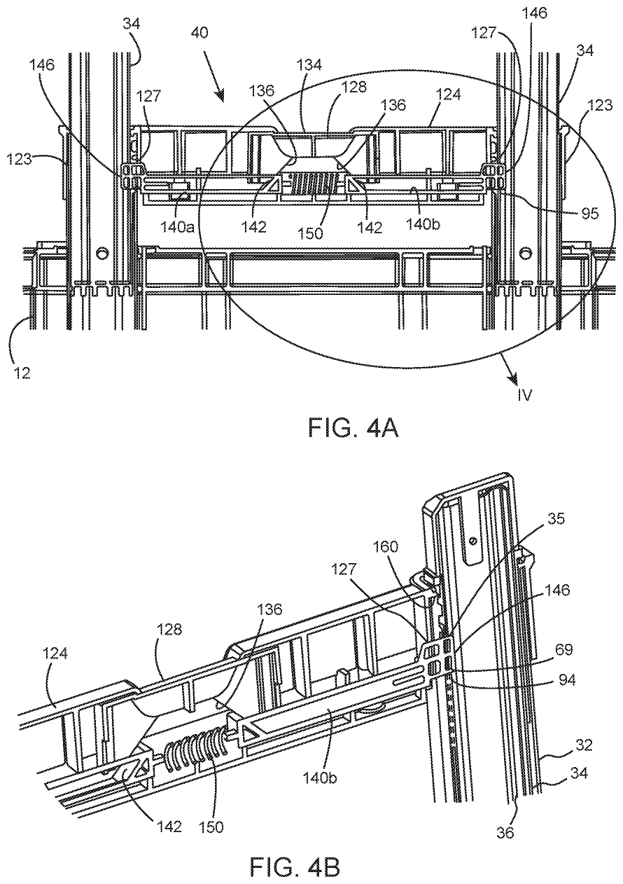

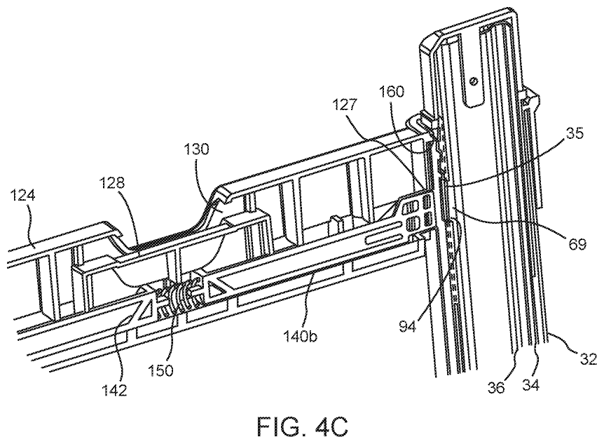

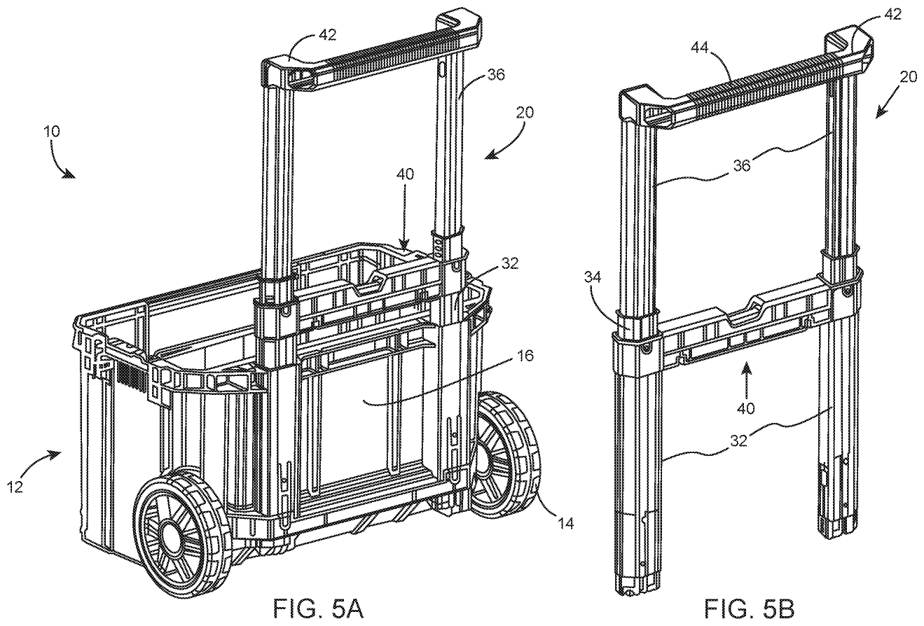

A slide sleeve 96 is fitted within a bottom end 98 of the first leg segment 32, fixed in place by a fastener (through opening 99) and configured for slidingly supporting the second leg segment 34 and facilitating penetration of a secondary plunger 62 through an aperture 100 configured at a side wall thereof, as will be discussed hereinafter. A top portion of the first leg segment 32 is configured with an opening 35 (FIG. 4C) at a side wall thereof, which at the fully retracted position coincides with other locking openings, as will become apparent here below.

Further attention is now made in particular to FIG. 2D, directed to the primary locking mechanism, generally designated 120, received within the bridge member 40, supported over and within a carrying bridge member 122 and covered by a bridge cover 124, the latter configured for snap articulation over the carrying bridge member 122. The primary locking mechanism 120 comprises a push-type actuator 128 accessible for pushing through an opening 130 configured at the bridge cover 124. The actuator 128 is configured with a push surface 134 and two activating surfaces 136 oppositely sloping with respect to an actuator displacing axis Y of the actuator (parallel to longitudinal axis X), i.e. sloping away from one another. It is seen that the actuator 128 has bifurcated side walls 135, such that in fact each side of the actuator 128 comprises two activating surfaces 136 with a recess 137 therebetween.

A pair of primary plungers 140a and 140b are received within the carrying bridge member 122 and are slidingly displaceable along a plunger axis Z extending normal to, and intersecting said actuator displacing axis Y. The primary plungers 140a and 140b are elongate members each configured at a neighboring end portion with a sloping activated surface 142, the respective activated surfaces extending at an opposite sense and being correspondently inclined with respect to said two activating surfaces 136 of the actuator 128. The primary plungers 140a and 140b have a longitudinal rib 144 slidingly received within the recess 137 of actuator 128, such that the sloping activated surface 142 is in fact split into two portions, mutually slidingly displaceable over the bifurcated activating surfaces 136. A fore end of the primary plungers 140a and 140b is configured with a locking tab 146, with a wing-like shoulder 148 provided for limiting axial displacement of the primary plungers 140a and 140b.

A coiled compression spring 150 is mounted over a projecting boss 154, coaxially with plunger axis Z, said spring configured for biasing the primary plungers 140a and 140b away from one another.

The arrangement is such that axial displacing of the push button actuator 128 along the actuator displacing axis Y, against the biasing effect of the coiled spring 150, results in the two activating surfaces 136 sliding over the corresponding activated surfaces 142, entailing axial displacement of the two primary plungers 140a and 140b towards one another along plunger axis Z, so as to contract, i.e. into unlocking the handle assembly, as will become apparent hereinafter. However, it is appreciated that the carrying bridge member 122 is configured at its opposite sides with a leg embracing portion 123, for positioning at a top portion of the respective first leg segments 32 and securing by fasteners through apertures 125. The leg embracing portions 123 are configured with an opening 127 (FIG. 2D) facilitating projection therethrough of the plunger locking tab 146 to be discussed below.

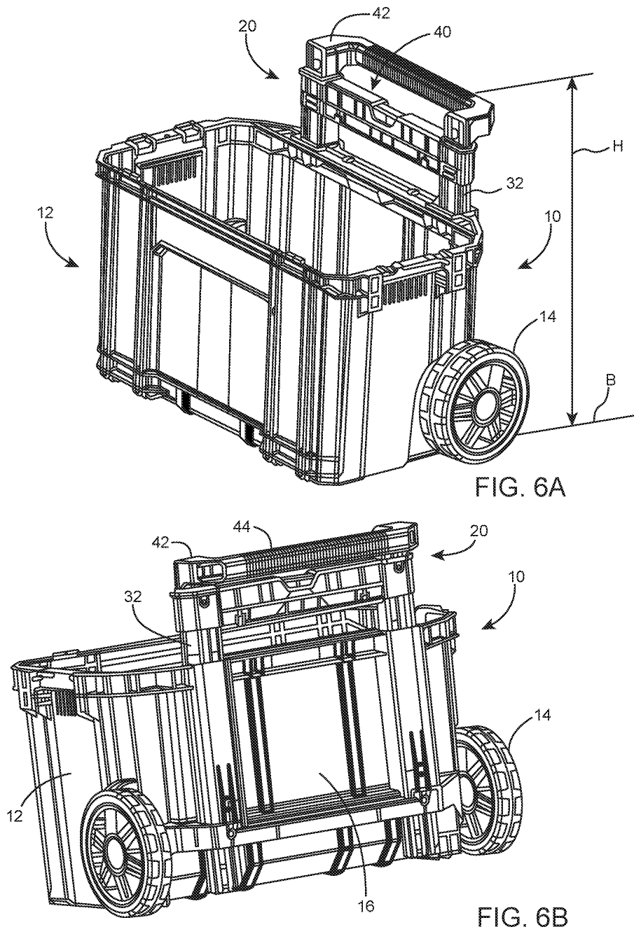

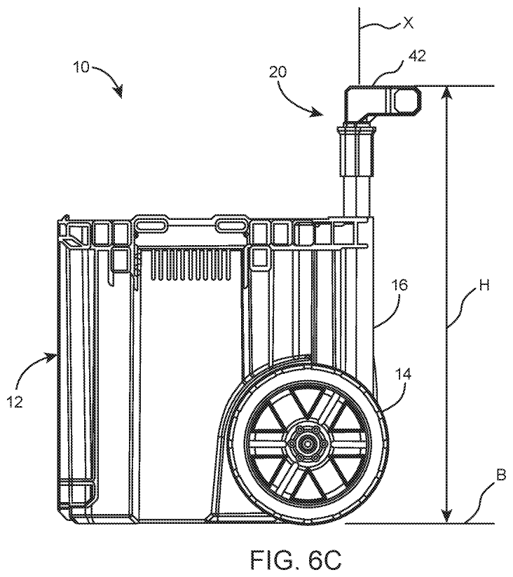

With further attention made also to the remaining drawings, it will now be explained how the handle assembly is transformed between its respective positions. When the container assembly 10 and the handle assembly 20 are at the retracted position (FIGS. 6A, 6B, 7A and 7B) the third leg segments 36 is telescopically retracted into the second leg segment 34 and the second leg segment 34 is retracted into the first leg segment 32. The arrangement is such that at this position the maximum height H of the container assembly, as measured at an upright position from the bottom surface (marked B in FIGS. 6A and 6C) to the top most surface of the manipulating handle 42 does not exceed 20″, rendering it suitable for stowing also at a restricted space.

At the retracted position, with the three leg segments telescopically retracted into one another, the primary locking mechanism 120 is configured to arrest the handle assembly 20 and prevent spontaneous (i.e. not manually operated) expansion thereof. Thus at the retracted position, the primary plungers 140a and 140b are at their expanded position (disposed away from one another) such that the locking tab 146 is received within the coinciding openings of the three leg segments, namely the locking tab 146 projects through opening 127 of leg embracing portion 123, through opening 35 at the top portion of the first leg segment 32, through opening 94 at the top portion of the second leg segment 34 and finally into the opening 69 at the top portion of the third leg segment 36. At this event, when all openings are in register with one another and with the locking tab 146 extending therethrough (FIG. 4B), the handle assembly is considered to be locked, so that the container assembly can be securely transported, and the handle assembly 20 will not spontaneously unlock even if the handle is pulled.

In order to prevent the coiled compression spring 66 of the secondary plunger 62 from being compressed for long period of time, i.e. when the handle assembly is retracted, slide sleeve 96 (at he first leg segment) the secondary plunger is free to penetrate into the opening 100 at the slide sleeve 96 (at the bottom of the first leg segment 32), so that spring 66 is relaxed, uncompressed (FIGS. 7B, 7C).

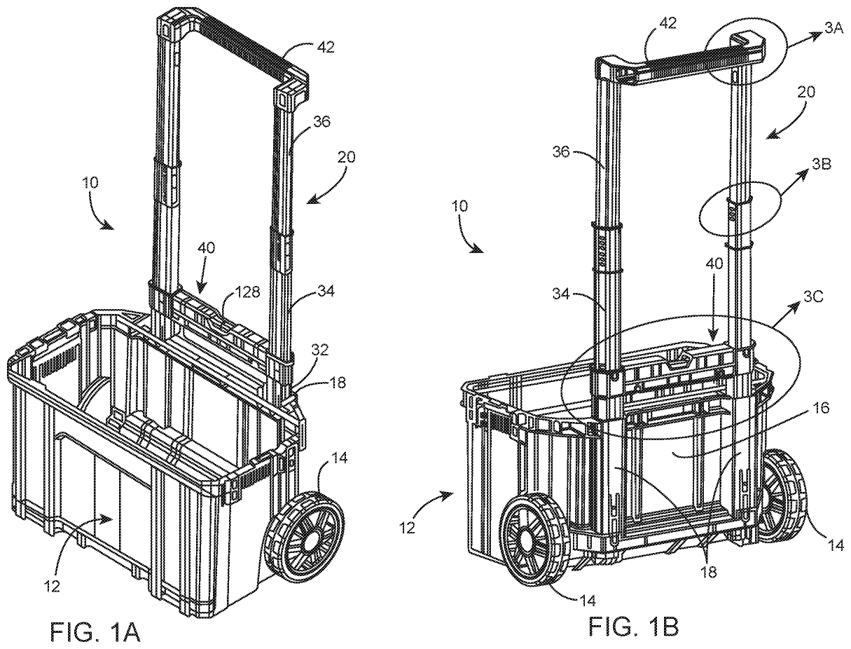

When it is required to expand the handle assembly 20 into the extended position (e.g. FIGS. 1A and 1B) the actuator 128 of the primary locking mechanism 120 should be depressed (along axis Y), against the biasing effect of coiled spring 150, resulting in simultaneous contraction of the primary plungers 140a and 140b (along axis Z, towards one another), whereby the locking tab 146 displaces from the arresting/locking position (as exemplified herein above, e.g. with reference to FIG. 4B) and disengages at least from the respective openings 94 and 69 of the second leg segment 34 and the third leg segment 36, to an unlocked position (FIG. 4C), facilitating their displacement into the expanded position.

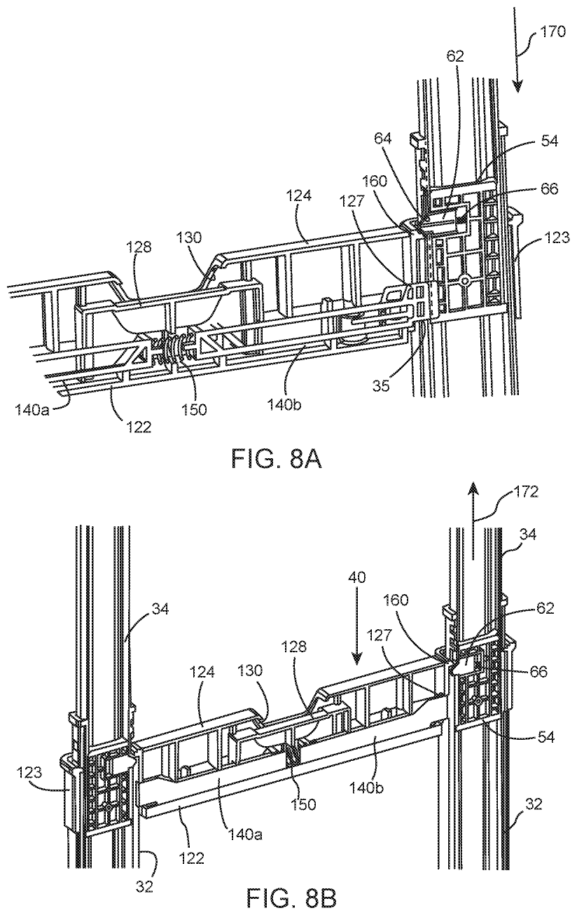

As the second leg segment 34 and the third leg segment 36 are withdrawn from the telescoping retracted position, the secondary locking mechanism 50 (which at the retreated position projects laterally outwards, in order to relax the spring 66) has to pass through a tight passage at the leg embracing portion 123. Accordingly, at a top portion of the leg embracing portion 123 there is an inwards projecting shoulder 160 (FIGS. 2D,4A, 4B, 8A and 8B) configured for retracting the secondary plunger 62 as it passes by. Thus, when the handle assembly is displaced into the retracted position (in direction of arrow 170), the bottom chamfered surface 72 of the secondary plunger 62 encounters the projecting shoulder 160 resulting in momentarily contraction of the secondary plunger 62 (FIG. 8A) facilitating passing through the tight space. Likewise, when the handle assembly is now being expanded, as the leg segments retract from one another (in direction of arrow 172), the top chamfered surface 76 of the secondary plunger 62 encounters the projecting shoulder 160 from below (FIG. 8B), resulting in momentarily contraction of the secondary plunger 62 (FIG. 8A) facilitating its passage through the tight space.

As already mentioned, the handle assembly can not spontaneously unlock, and it is required that the primary locking mechanism 120 be manually unlocked. By depressing the actuator 128, at least at an initial unlocking stage. Then, the handle leg members can be fully expanded. As this occurs, the second leg segment 34 is pulled out to a position at which the locking opening 95 (at a bottom end portion thereof) extends opposite the locking tab 146 of the respective primary plunger 140a/140b, facilitating the later to snap into its arresting, locked position. As the handle assembly is further pulled out, when the third leg segment 36 expands from the second leg segment 34, the secondary plunger 62 reaches the position at which it faces in register with the opening 94 at the top portion of the second leg segment 34, such that the secondary plunger 62 snaps into its locking position within the opening 94 (with flat surface 94 bearing over an edge of opening 64), so that the handle assembly is now locked at the fully expanded position and will not retract unless the primary locking mechanism 120 is momentarily unlocked, and whereupon unlocking of the secondary locking mechanism 50 takes place in cascade, only after the second leg segment 34 retracts into the first leg segment 32. At the retracted position, the container assembly 10 can be easily manipulated by tilting over and rolling over the wheels 14.

1. A wheeled container assembly comprising at least a base container, said base container configured with a wheel set disposed at a rear portion thereof, and a handle assembly, said handle assembly comprising:
a pair of parallelly disposed leg members, each leg member comprising a first leg segment articulated at a back wall portion of the base container, a second leg segment telescopically displaceable with respect to said first leg segment, and a third leg segment telescopically displaceable with respect to said second leg segment; a bridge member rigidly extending between an upper portion the first leg segments, and a manipulating handle rigidly extending between a top portion of the third leg segments;
the leg members are configurable between a locked extended position at which the leg segments of a leg member are telescopically extended with respect to one another, and a locked retracted position at which the leg segments of a leg member are telescopically retracted and the handle assembly assumes a minimal height; and
a primary locking mechanism disposed at the bridge member and configured for arresting the second leg segment within the first leg segment and the third leg segment within the second leg segment, at the retracted position; and a secondary locking mechanism disposed within a bottom portion of the third leg segment and configured for arresting the third leg segment at the extended position with respect to the second leg segment; and wherein retracting the third leg segment into the second leg segment is facilitated after retraction of the second leg segment into the first leg segment.

2. The wheeled container according to claim 1, wherein at the retracted position the primary locking mechanism arrests the second leg segment and third leg second within the first leg segment, thereby preventing the handle assembly from displacing into its expanded position.

3. The wheeled container according to claim 1, wherein displacing the handle assembly from the retracted portion into the expanded position is possible only upon unlocking the primary locking mechanism.

4. The wheeled container according to claim 1, wherein expanding a leg member is facilitated only upon manually releasing the primary locking mechanism, whereupon the secondary locking mechanism spontaneously displaces into a momentarily open position, facilitating axial withdrawal of the second leg segment and the second leg segment, respectively, into the fully expanded position.

5. The wheeled container according to claim 1, wherein collapsing of the handle assembly is facilitated only upon manually releasing the primary locking mechanism, enabling axial collapsing of the second leg segment and the third leg segment into the first leg segment, at a telescoping mode, whereupon the secondary locking mechanism spontaneously displaces into a momentarily open position.

6. (canceled)

7. The wheeled container according to claim 1, wherein the primary locking mechanism comprises a primary plunger configured for snap engagement within a first arresting recess configured at a top portion of the first leg segment and a second arresting recess at a bottom portion of the second leg segment, said first arresting recess and second arresting recess being disposed in register with one another.

8. The wheeled container according to claim 7, wherein when the primary plunger is engaged within both said first arresting recess and second arresting recess, the second leg segment is arrested at its extended position with respect to the first leg segment, and when the primary plunger is retracted against its biasing, said second leg segment can be retracted into the collapsed position within the first leg segment.

9. The wheeled container according to claim 7, wherein the primary plunger is normally biased into a locked position, wherein a locking tip of the primary plunger projects from a side portion of the bridge member, and is configured for projecting through an aperture configured at a top portion of the first leg segment into locking arresting of the second leg segment and the third leg segment, through a locking aperture configured at a top portion of each leg segment, respectively.

10. The wheeled container according to claim 7, wherein the primary plunger is normally biased, or articulated with a biasing arrangement, configured for projecting into the arresting position.

11. The wheeled container according to claim 7, wherein the primary locking mechanism is configured with an unlocking mechanism configured for contracting the normally biased primary plunger into an unlocked position thereof.

12. The wheeled container according to claim 11, wherein the unlocking mechanism is biased so as to normally retain a locked position.

13. The wheeled container according to claim 11, wherein the unlocking member comprises an actuator configured for retracting the primary plunger from its arresting position where it projects into a locking aperture at the top portion of the first leg segment, at the extended position, or into coinciding locking apertures at the top portion of all leg segments, at the retracted position.

14. The wheeled container according to claim 13, wherein the actuator is configured for simultaneous retracting two primary plungers, towards one another, each associated with a respective leg member of the handle assembly.

15. The wheeled container according to claim 13, wherein the actuator is a push button received at a center portion of the bridge member and configured with two activating surfaces oppositely sloping with respect to an actuator displacing axis of the actuator, whilst two primary plungers are received within the bridge member and are slidingly displaceable along a plunger axis extending normal to said actuator displacing axis; each of said primary plungers is configured at a neighboring end portion with a sloping activated surface, the respective activated surfaces extending at an opposite sense and being correspondently inclined with respect to said two activating surfaces.

16. The wheeled container according to claim 15, wherein axial displacing of the actuator along the actuator displacing axis results in the two activating surfaces sliding over the corresponding activated surfaces, entailing axial displacement of the two primary plungers towards one another, along the plunger axis, so as to contract into unlocking the handle assembly.

17. The wheeled container according to claim 1, wherein the secondary locking mechanism comprises a secondary plunger disposed within a bottom portion of the third leg segment, said secondary plunger being normally biased to project from a recess at a side wall of the third leg segment and is configured to snap into arresting engagement within a recess disposed in register at a top portion of the second leg segment.

18. (canceled)

19. The wheeled container according to claim 17, wherein the secondary plunger is spring loaded into its normally biased position, wherein at the retracted position and at the extended position the spring is substantially at a non-compressed/tensioned position.

20. The wheeled container according to claim 17, wherein upon retraction displacing of the second leg segment into the first leg segment, the secondary plunger, projecting through an aperture at the third leg segment and a corresponding aperture at the second leg segment, encounters a top release shoulder configured at a top portion of the bridge member, wherein further axial displacing of the leg member into the retracted position entails momentary contraction of the secondary plunger to thereby facilitate further displacement into the fully retracted position.

21. The wheeled container according to claim 20, wherein upon axially extending the third leg segment and the second leg segment from the fully retracted position, in an upwards direction, the secondary plunger encounters a bottom release shoulder, resulting in momentary contraction of the secondary plunger, facilitating full extension of the third leg segment from the second leg segment, into full leg member expansion.

22. The wheeled container according to claim 1, wherein extending the third leg segment from the second leg segment is facilitated in cascade, after extending the second leg segment from the first leg segment.

23. (canceled)

24. The wheeled container according to claim 1, wherein the manipulating handle extends offset with respect to a longitudinal axis of the leg members, such that an innermost face thereof extends spaced from an outermost face of the bridge member.

25. (canceled)

26. The wheeled container according to claim 1, wherein retracting or expanding the handle assembly is facilitated only upon releasing the primary locking mechanism.

27. A handle assembly for a container, the handle assembly comprising a pair of parallelly disposed leg members, each leg member comprising a first leg segment articulable to the container, a second leg segment telescopically displaceable with respect to said first leg segment, and a third leg segment telescopically displaceable with respect to said second leg segment; a bridge member rigidly extending between an upper portion the first leg segments, and a manipulating handle rigidly extending between a top portion of the third leg segments;
the leg members are configurable between a locked extended position, at which the leg segments of a leg member are telescopically extended with respect to one another, and a locked retracted position, at which the leg segments of a leg member are telescopically retracted and the handle assembly assumes a minimal height;
a primary locking mechanism disposed at the bridge member and configured for arresting the second leg segment within the first leg segment and the third leg segment within the second leg segment, at the retracted position; and a secondary locking mechanism disposed within a bottom portion of the third leg segment and configured for arresting the third leg segment at the extended position with respect to the second leg segment; and wherein retracting the third leg segment into the second leg segment is facilitated after retraction of the second leg segment into the first leg segment.
